(19) United States
(12) Patent Application Publication
(10) Pub. No.: US 2014/0286458 A1
(43) Pub. Date: Sep. 25, 2014

(54) RECEIVING APPARATUS AND RECEIVING METHOD

(71) Applicant: FUJITSU LIMITED, Kawasaki-shi (JP)

(72) Inventors: AKIO SASAKI, Yokohama (JP); Mitsuhiko Manpo, Sapporo (JP); Yukihiko OSHIKIRI, Sapporo (JP)

(73) Assignee: FUJITSU LIMITED, Kawasaki-shi (JP)

(21) Appl. No.: 14/168,668

(22) Filed: Jan. 30, 2014

(30) Foreign Application Priority Data
Mar. 21, 2013 (JP) 2013-059118

(51) Int. Cl. H04B 7/04

(52) U.S. Cl. CPC H04B 7/0413
USPC 375/340; 375/316

(57) ABSTRACT

An RF-LSI receives a first signal transmitted with a first system frequency and a second signal transmitted with a second system frequency. In the RF-LSI 50, a frequency converter 55 performs frequency conversion on the received first signal (i.e., a master-received signal) and the received second signal (i.e., a slave-received signal) such that the first signal and the second signal do not overlap each other on the frequency axis and the frequency of each of the first signal and the second signal falls within a range containing a reference frequency and having a predetermined bandwidth. A mixer mixes the first signal subjected to the frequency conversion and the second signal subjected to the frequency conversion. An ADC performs analog-to-digital conversion on the mixed signal.

### CROSS-REFERENCE TO RELATED APPLICATION(S)

This application is based upon and claims the benefit of priority of the prior Japanese Patent Application No. 2013-059118, filed on Mar. 21, 2013, the entire contents of which are incorporated herein by reference.

### FIELD

The embodiments discussed herein are related to a receiving apparatus and a receiving method.

### BACKGROUND

Conventionally, wireless communication using multiple antennas (hereinafter, may be referred to as “multi-antenna communication”) has been performed. Examples of the multi-antenna communication include diversity communication and multiple-input and multiple-output (MIMO) communication. In the diversity communication and the MIMO communication, signals with the same frequency are transmitted via multiple antennas. In the diversity communication, signals with the same contents are transmitted via multiple antennas. Therefore, it is possible to improve an error rate or the like, enabling to improve the communication quality. Furthermore, in the MIMO communication, signals with different contents are transmitted via multiple antennas. Therefore, it is possible to improve a transmission rate.

FIG. 1 is a block diagram illustrating an example of a conventional multi-antenna communication apparatus. As illustrated in FIG. 1, the multi-antenna communication apparatus includes, for example, two antennas, a duplexer (DUP), a power amplifier (PA), a radio frequency-large scale integration (RF-LSI), a bandpass filter (BPF), and a baseband processor. The duplexer, the power amplifier, the RF-LSI, and the bandpass filter are included in a wireless transmitting/receiving circuit. The multi-antenna communication apparatus also includes one transmission system and two reception systems. For example, in the transmission system, a transmission signal passes through the RF-LSI, the power amplifier, the duplexer, and a first antenna in this order. Furthermore, in a first reception system, a reception signal passes through the first antenna, the duplexer, the power amplifier, and the RF-LSI in this order. Moreover, in a second reception system, a reception signal passes through a second antenna, the bandpass filter and the RF-LSI in this order. In the following, for the sake of convenience, the first reception system may be referred to as “Primary Rx (P-Rx)”, and the second reception system may be referred to as “Secondary-Rx (S-Rx)”.

Furthermore, in wireless communication services, multiple “operating band”, such as the 2 GHz band, the 1.7 GHz band, and the 800 MHz band, are provided. The multi-antenna communication apparatus includes a transmission system and a reception system corresponding to each of the operating bandwidths so that the multi-antenna communication apparatus can perform communication using each of the multiple operating bandwidths.

FIG. 2 is a block diagram illustrating an example of a multi-antenna communication apparatus compatible with multiple operating bands. In FIG. 2, the multi-antenna communication apparatus compatible with three bands BAND a, BAND b, and BAND c is illustrated.

In the multi-antenna communication apparatus illustrated in FIG. 2, a transmission system includes three transmission sub systems. For example, in a first transmission sub system, a transmission signal passes through a power amplifier and a duplexer compliant with BAND a. In a second transmission sub system, a transmission signal passes through a power amplifier and a duplexer compliant with BAND b. In a third transmission sub system, a transmission signal passes through a power amplifier and a duplexer compliant with BAND c. A first switch (SW) switches from one transmission sub system to another to be a connection object, so that the transmission signal is transmitted by the transmission sub system connected to the first switch (SW) via the first antenna.

Furthermore, in the multi-antenna communication apparatus illustrated in FIG. 2, a first reception system includes three reception sub systems. For example, in a first reception sub system, a reception signal passes through a duplexer compliant with BAND a. In a second reception sub system, a reception signal passes through a duplexer compliant with BAND b. In a third reception sub system, a reception signal passes through a duplexer compliant with BAND c. The first switch switches from one reception sub system to another to be a connection object, to thereby output the reception signal to the reception sub system connected to the first switch.

Furthermore, in the multi-antenna communication apparatus illustrated in FIG. 2, a second reception system includes three reception sub systems. For example, in a fourth reception sub system, a reception signal passes through a bandpass filter compliant with BAND a. In a fifth reception sub system, a reception signal passes through a bandpass filter compliant with BAND b. In a sixth reception sub system, a reception signal passes through a bandpass filter compliant with BAND c. A second switch switches from one reception sub system to another to be a connection object, to thereby output the reception signal to the reception sub system connected to the second switch.

Incidentally, in recent years, communication using multiple frequency bands has been studied in order to increase the bandwidth. For example, in the 3GPP LTE-Advanced (the 3rd Generation Partnership Project Radio Access Network Long Term Evolution Advanced) that is one of the communication standards, a technology called carrier aggregation has been studied. The carrier aggregation is a communication technology for using multiple component carriers. In other words, the carrier aggregation is a technology that enables communication using different frequency bands at the same time. Here, the component carrier means a unit of a frequency band available for communication. In the following, the component carrier may be denoted by “CC”. Furthermore, the carrier aggregation may be denoted by “CA”.

To integrate multiple CCs in CA, three modes as described below are available. FIGS. 3, 4, and 5 are diagrams illustrating examples of the modes of the carrier aggregation to integrate component carriers. The modes are applied commonly to transmission and reception.

(Mode 1) Frequencies of multiple operating bands are used simultaneously. For example, as illustrated in FIG. 3, two CCs of different operating bands such as BAND a and BAND b are used simultaneously. This mode of the CA may be referred to as inter-band non-contiguous CA.

(Mode 2) Multiple non-contiguous frequencies in a single operating band are used simultaneously. For example, as illustrated in FIG. 4, two non-contiguous CCs in BAND a are used simultaneously. This mode of the CA may be referred to as intra-band non-contiguous CA.

(Mode 3) Multiple contiguous frequencies in a single operating band are used simultaneously. For example, as illustrated in FIG. 5, two contiguous CCs in BAND a are used simultaneously. This mode of the CA may be referred to as intra-band contiguous CA.

By simultaneously using multiple frequencies as described above, it becomes possible to improve the frequency use efficiency and the transmission rate. Conventional examples are described in Japanese Laid-open Patent Publication No. 2011-019074.

However, in the multi-antenna communication apparatus that receives signals transmitted with multiple non-contiguous frequencies as in the mode 1 or mode 2 as described above, if the RF-LSI is simply provided for each of the frequencies, the size of the receiving circuit and the power consumption increase. Furthermore, even if the RF-LSIs compatible with the multiple frequencies are combined into one chip, the size of the chip increases, so that the size of the receiving circuit and the power consumption increase even in this case.

### SUMMARY

According to an aspect of an embodiment, a receiving apparatus that receives a first signal transmitted with a first frequency and a second signal transmitted with a second frequency, the receiving apparatus including: a frequency converter that performs frequency conversion on the received first signal and the received second signal, and outputs a frequency-converted first signal and a frequency-converted second signal, the frequency-converted first and second signals not overlapping each other on a frequency axis and the frequency of each of the frequency-converted first and second signals falling within a range containing a reference frequency and having a predetermined bandwidth; a mixer that mixes the frequency-converted first signal and the frequency-converted second signal to obtain a mixed signal; and an analog-to-digital converter that performs analog-to-digital conversion on the mixed signal

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a block diagram illustrating an example of a conventional multi-antenna communication apparatus;

FIG. 2 is a block diagram illustrating an example of a multi-antenna communication apparatus compatible with multiple operating bands;

FIG. 3 is a diagram illustrating an example of a mode of carrier aggregation to integrate component carriers;

FIG. 4 is a diagram illustrating an example of another mode of carrier aggregation to integrate component carriers;

FIG. 5 is a diagram illustrating an example of still another mode of carrier aggregation to integrate component carriers;

FIG. 6 is a block diagram illustrating an example of a multi-antenna communication apparatus according to a first embodiment;

FIG. 7 is a block diagram illustrating an example of a wireless transmitting/receiving circuit according to the first embodiment;

FIG. 8 is a block diagram illustrating main functions of a first receiving unit and a second receiving unit;

FIG. 9 is a block diagram illustrating an example of a specific circuit configuration of an RF-LSI according to the first embodiment;

FIG. 10 is a diagram illustrating a general configuration of a quadrature demodulator;

FIG. 11 is a diagram for explaining a phase shifter;

FIG. 12 is a diagram for explaining a relationship between an input signal and an output signal of the phase shifter;

FIG. 13 is a diagram illustrating a configuration of a general frequency converter;

FIG. 14 is a diagram for explaining frequency conversion by quadrature demodulation;

FIG. 15 is a diagram for explaining the frequency conversion by the quadrature demodulation;

FIG. 16 is a diagram for explaining the frequency conversion by the quadrature demodulation;

FIG. 17 is a diagram for explaining the frequency conversion by the quadrature demodulation;

FIG. 18 is a diagram for explaining a frequency conversion process performed by a frequency converter according to the first embodiment;

FIG. 19 is a diagram for explaining the frequency conversion process performed by the frequency converter according to the first embodiment;

FIG. 20 is a block diagram illustrating an example of a specific circuit configuration of an RF-LSI according to a second embodiment;

FIG. 21 is a diagram for explaining a frequency conversion process performed by a frequency converter according to the second embodiment;

FIG. 22 is a diagram for explaining the frequency conversion process performed by the frequency converter according to the second embodiment;

FIG. 23 is a diagram for explaining the frequency conversion process performed by the frequency converter according to the second embodiment;

FIG. 24 is a block diagram illustrating a configuration of an RF-LSI according to a first modification of the second embodiment;

FIG. 25 is a block diagram illustrating a configuration of an RF-LSI according to a second modification of the second embodiment; and

FIG. 26 is a block diagram illustrating an example of a specific circuit configuration of an RF-LSI according to a third embodiment.

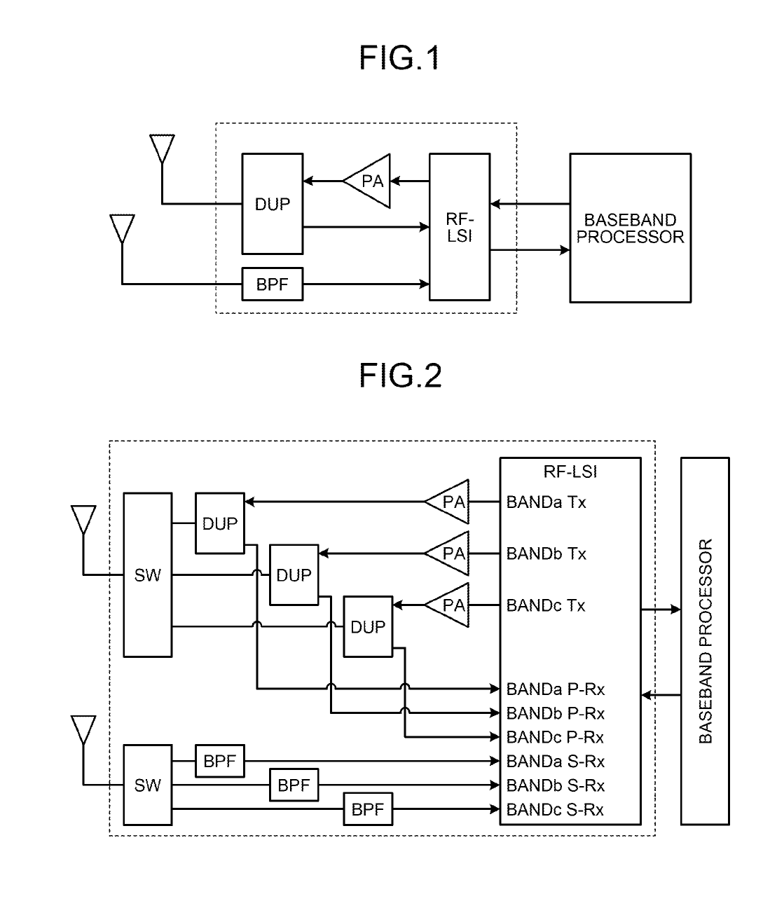

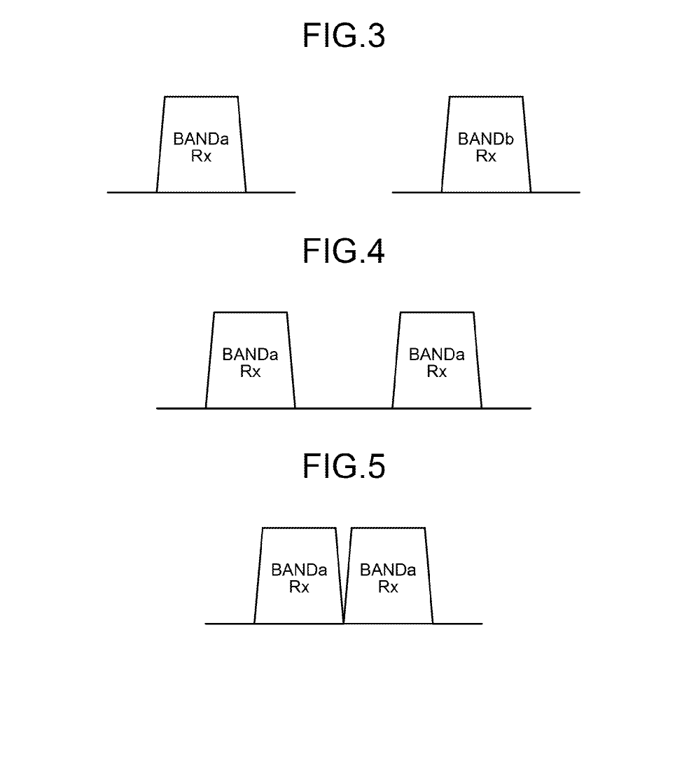

### DESCRIPTION OF EMBODIMENT(S)

Preferred embodiments of the present invention will be explained with reference to accompanying drawings. The receiving apparatus and the receiving method disclosed in the invention are not limited to the embodiments below. The embodiments will be explained on the assumption that CA communication of an LTE-Advanced system is employed as communication that uses multiple frequencies at the same time; however, the present invention is not limited thereto. Furthermore, in the embodiments, components with the same functions are denoted by the same reference numerals or symbols, and the same explanation will be omitted.

### [a] First Embodiment

Configuration Example of a Multi-Antenna Communication Apparatus

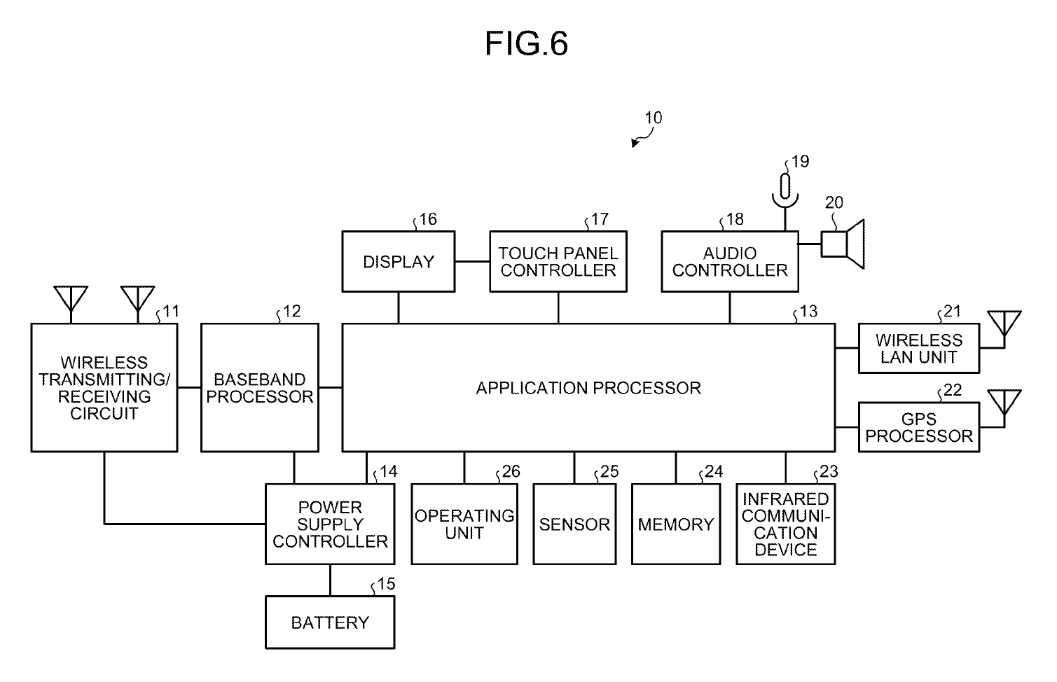

FIG. 6 is a block diagram illustrating an example of a multi-antenna communication apparatus according to a first embodiment. In FIG. 6, a multi-antenna communication apparatus 10 includes a wireless transmitting/receiving circuit 11, a baseband processor 12, an application processor 13, a power supply controller 14, and a battery 15. The multi-antenna communication apparatus 10 also includes a display 16, a touch panel controller 17, an audio controller 18, a microphone 19, and a speaker 20. The multi-antenna communication apparatus 10 also includes a wireless local area network (LAN) unit 21, a global positioning system (GPS) processor 22, an infrared communication device 23, a memory 24, a sensor 25, and an operating unit 26. The baseband processor 12 and the application processor 13 may be, for example, a central processing unit (CPU), a digital signal processor (DSP), a field programmable gate array (FPGA), or the like. The memory 24 may be a random access memory (RAM) such as a synchronous dynamic random access memory (SDRAM), a read only memory (ROM), a flash memory, or the like.

The wireless transmitting/receiving circuit 11 is configured to receive a signal transmitted by the CA. The wireless transmitting/receiving circuit 11 performs a predetermined reception wireless process, that is, down conversion, analog-to-digital conversion, or the like, on the signal received via an antenna, and outputs the reception signal subjected to the reception wireless process to the baseband processor 12. Furthermore, the wireless transmitting/receiving circuit 11 performs a predetermined transmission wireless process, that is, digital-to-analog conversion, up conversion, or the like, on a baseband signal received from the baseband processor 12, and transmits the signal subjected to the transmission wireless process via the antenna. The baseband signal transmitted between the wireless transmitting/receiving circuit 11 and the baseband processor 12 contain an I signal and a Q signal. Furthermore, a control signal (for example, an RF-LSI control signal) for controlling the wireless transmitting/receiving circuit 11 may be multiplexed with the baseband signal output from the baseband processor 12 to the wireless transmitting/receiving circuit 11. Moreover, various types of monitoring information in the wireless transmitting/receiving circuit 11 may be multiplexed with the baseband signal output from the wireless transmitting/receiving circuit 11 to the baseband processor 12.

The baseband processor 12 performs a predetermined reception baseband process, that is, demodulation, decoding, or the like, on the baseband signal received from the wireless transmitting/receiving circuit 11, and outputs the obtained reception data to the application processor 13. Furthermore, the baseband processor 12 performs a predetermined transmission baseband process, that is, encoding, modulation, or the like, on the transmission data received from the application processor 13, and outputs the obtained baseband signal to the wireless transmitting/receiving circuit 11.

The application processor 13 runs various applications and controls the entire multi-antenna communication apparatus 10. The application processor 13 also outputs transmission data generated by the running application to the baseband processor 12. The application processor 13 also performs a process according to the application on the reception data received from the baseband processor 12.

The power supply controller 14 supplies electric power charged in the battery 15 to each functional unit.

The display 16 is an output interface that displays various types of information on a screen. The display 16 has a touch panel function.

The touch panel controller 17 controls the touch panel function of the display 16.

The audio controller 18 controls the microphone 19 and the speaker 20. The microphone 19 is an input interface that picks up various sounds. The speaker 20 is an output interface that outputs various sounds.

The wireless LAN unit 21 controls transmission and reception of signals using wireless LAN communication. It may be possible to use Bluetooth (registered trademark) communication instead of the wireless LAN communication.

The GPS processor 22 acquires location information on the multi-antenna communication apparatus 10.

The infrared communication device 23 controls transmission and reception of signals using the infrared communication.

The memory 24 stores therein various programs, various types of data, and the like used by the application processor 13. The application processor 13 reads the programs stored in the memory 24 and executes the programs, to thereby implement various processes.

The sensor 25 outputs various sensor values to the application processor 13. The sensor 25 includes, for example, an acceleration sensor. The operating unit 26 is an input interface that inputs various types of information.

Configuration Example of the Wireless Transmitting/Receiving Circuit

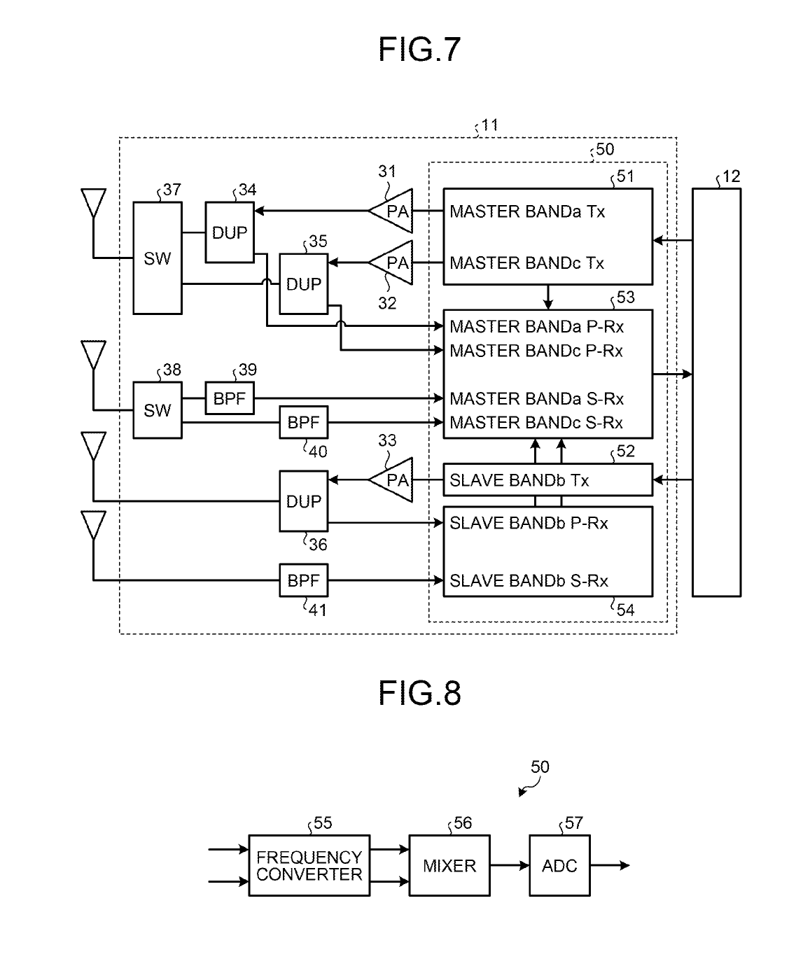

FIG. 7 is a block diagram illustrating an example of the wireless transmitting/receiving circuit according to the first embodiment. In FIG. 7, the wireless transmitting/receiving circuit 11 includes power amplifiers 31, 32, and 33, duplexers 34, 35, and 36, switches 37 and 38, bandpass filters 39, 40, and 41, and an RF-LSI 50. Here, the power amplifiers 31 and 32, the duplexers 34 and 35, the switches 37 and 38, and the bandpass filters 39 and 40 are compatible with one operating band (for example, BAND a or BAND c) used in the CA, and this operating band is referred to as “a master band” for the sake of convenience. Furthermore, the power amplifier 33, the duplexer 36, and the bandpass filter 41 are compatible with the other operating band (for example, BAND b), and this operating band is referred to as “a slave band” for the sake of convenience.

The power amplifier 31 receives a signal to be transmitted through BAND a from the RF-LSI 50, amplifies the signal, and outputs the amplified signal to the duplexer 34. The amplified signal output to the duplexer 34 is transmitted via the switch 37 and the antenna when BAND a is selected as the master band.

The power amplifier 32 receives a signal to be transmitted through BAND c from the RF-LSI 50, amplifies the signal, and outputs the amplified signal to the duplexer 35. The amplified signal output to the duplexer 35 is transmitted via the switch 37 and the antenna when BAND c is selected as the master band.

When BAND a is selected as the master band, the duplexer 34 receives the reception signal via the switch 37 and outputs the reception signal to the RF-LSI 50.

When BAND c is selected as the master band, the duplexer 35 receives the reception signal via the switch 37 and outputs the reception signal to the RF-LSI 50.

When BAND a is selected as the master band, the bandpass filter 39 receives the reception signal via the switch 38, cuts an undesired signal component, and outputs the reception signal containing a desired signal component to the RF-LSI 50.

When BAND c is selected as the master band, the bandpass filter 40 receives the reception signal via the switch 38, cuts an undesired signal component, and outputs the reception signal containing a desired signal component to the RF-LSI 50.

The power amplifier 33 receives a signal to be transmitted through BAND b from the RF-LSI 50, amplifies the signal, and outputs the amplified signal to the duplexer 36. The amplified signal output to the duplexer 36 is transmitted via the antenna.

When BAND b is selected as the slave band, the duplexer 36 receives the reception signal via the antenna and outputs the reception signal to the RF-LSI 50.

When BAND b is selected as the slave band, the bandpass filter 41 receives the reception signal via the antenna, cuts an undesired signal component, and outputs the reception signal containing a desired signal component to the RF-LSI 50.

The RF-LSI 50 receives the reception signal, performs a predetermined reception wireless process, that is, down conversion, analog-to-digital conversion, or the like, on the reception signal, outputs the reception signal subjected to the reception wireless process to the baseband processor 12. Furthermore, the RF-LSI 50 performs a predetermined transmission wireless process, that is, digital-to-analog conversion, up conversion, or the like, on the baseband signal received from the baseband processor 12, and outputs the signal subjected to the transmission wireless process.

For example, the RF-LSI 50 includes a first transmitting unit 51 compatible with the master band, a second transmitting unit 52 compatible with the slave band, a first receiving unit 53 compatible with the master band, and a second receiving unit 54 compatible with the slave band.

The first transmitting unit 51 receives a baseband signal to be transmitted through the master band from the baseband processor 12, performs a predetermined transmission wireless process on the signal, and outputs the processed signal.

The second transmitting unit 52 receives a baseband signal to be transmitted through the slave band from the baseband processor 12, performs a predetermined transmission wireless process on the signal, and outputs the processed signal.

The second receiving unit 54 performs frequency conversion on the signal received through the slave band (hereinafter, the signal may be referred to as “a slave-received signal”) such that the frequency approaches “a reference frequency”, and outputs the frequency-converted slave-received signal to the first receiving unit 53.

The first receiving unit 53 performs frequency conversion on a signal received through the master band (hereinafter, the signal may be referred to as “a master-received signal”) such that the frequency approaches “a reference frequency”. The first receiving unit 53 mixes the frequency-converted master-received signal and the frequency-converted slave-received signal, and performs an analog-to-digital conversion process or the like on the mixed signal. The frequency conversion process will be described in detail later.

FIG. 8 is a block diagram illustrating main functions of the first receiving unit and the second receiving unit. As illustrated in FIG. 8, the RF-LSI 50 includes a frequency converter 55, a mixer 56, and an analog-to-digital converter (ADC) 57.

The frequency converter 55 converts the frequency of each of the master-received signal and the slave-received signal such that the master-received signal and the slave-received signal do not overlap each other on the frequency axis and such that the frequency of each of the signals falls within a range containing the reference frequency and having a predetermined bandwidth. In the first embodiment, the reference frequency is a direct-current frequency (that is, 0 Hz).

The mixer 56 mixes the frequency-converted master-received signal and the frequency-converted slave-received signal. The mixed signal contains a component corresponding to the master-received signal and a component corresponding to the slave-received signal such that the components do not overlap each other on the frequency axis. Therefore, if a process is performed on the mixed signal in the subsequent stage, the process can be performed on each of the components.

The analog-to-digital converter 57 performs an analog-to-digital conversion process on the mixed signal. In this case, similarly to the above, the analog-to-digital conversion process is performed on each of the component corresponding to the master-received signal and the component corresponding to the slave-received signal.

Circuit Configuration Example of the RF-LSI

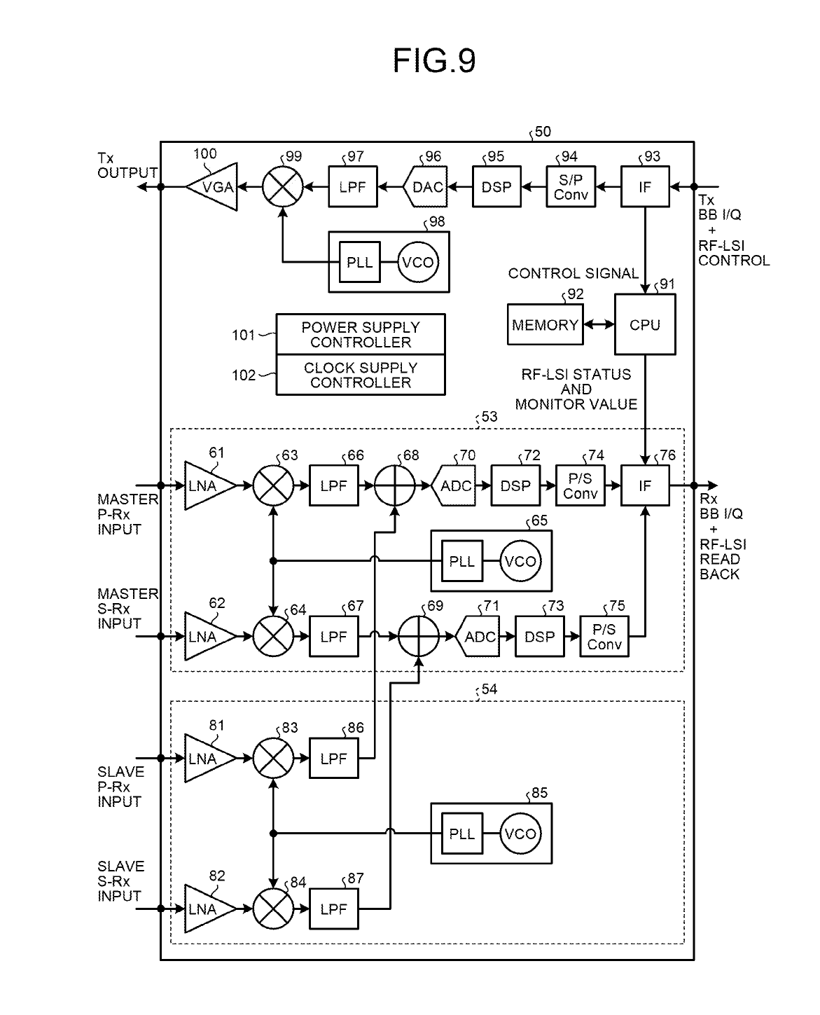

An example of a specific circuit configuration of the RF-LSI 50 will be explained below. FIG. 9 is a block diagram illustrating an example of a specific circuit configuration of the RF-LSI according to the first embodiment.

In FIG. 9, the RF-LSI 50 includes the first receiving unit 53 and the second receiving unit 54. The first receiving unit 53 includes low noise amplifiers (LNAs) 61 and 62, quadrature demodulators 63 and 64, a local oscillator 65, low-pass filters (LPFs) 66 and 67, mixers 68 and 69, and analog-to-digital converters (ADCs) 70 and 71. The first receiving unit 53 also includes digital signal processors (DSP) 72 and 73, parallel-serial converters 74 and 75, and an interface (IF) 76. The second receiving unit 54 includes LNAs 81 and 82, quadrature demodulators 83 and 84, a local oscillator 85, and LPFs 86 and 87. Each of the local oscillator 65 and the local oscillator 85 includes a voltage-controlled oscillator (VCO) and a phase locked loop (PLL).

Furthermore, the RF-LSI 50 includes a central processing unit (CPU) 91, a memory 92, an interface 93, a serial-parallel convertor 94, a DSP 95, a digital-to-analog converter (DAC) 96, and an LPF 97. Moreover, the RF-LSI 50 includes a local oscillator 98, a quadrature modulator 99, a variable gain amplifier (VGA) 100, a power supply controller 101, and a clock supply controller 102.

In the circuit configuration of the RF-LSI 50, the first receiving unit 53 and the second receiving unit 54 are provided for each of the operating bands. However, for the sake of convenience, only a single first receiving unit 53 and a single second receiving unit 54 are illustrated in FIG. 9. Furthermore, FIG. 9 illustrates a circuit configuration for performing the CA in only the downlink by way of example.

In the second receiving unit 54, the LNA 81 amplifies a slave-received signal received by the first reception system (hereinafter, the signal may be referred to as “a first slave-received signal”), and outputs the amplified first slave-received signal to the quadrature demodulator 83. Furthermore, the LNA 82 amplifies a slave-received signal received by the second reception system (hereinafter, the signal may be referred to as “a second slave-received signal”), and outputs the amplified second slave-received signal to the quadrature demodulator 84.

The quadrature demodulator 83 performs quadrature demodulation on the first slave-received signal received from the LNA 81, by using a second local oscillator signal with a local frequency fl₂ output by the local oscillator 85. Subsequently, the quadrature demodulator 83 outputs the first slave-received signal subjected to the quadrature demodulation to the LPF 86. The first slave-received signal subjected to the quadrature demodulation contains an I signal and a Q signal. The LPF 86 removes an unnecessary frequency component from the first slave-received signal subjected to the quadrature demodulation, and outputs the signal to the mixer 68 of the first receiving unit 53.

The quadrature demodulator 84 performs quadrature demodulation on the second slave-received signal received from the LNA 82, by using the second local oscillator signal with the local frequency fl₂ output by the local oscillator 85. Subsequently, the quadrature demodulator 84 outputs the second slave-received signal subjected to the quadrature demodulation to the LPF 87. The second slave-received signal subjected to the quadrature demodulation is an analog baseband signal containing an I signal and a Q signal. The LPF 87 removes an unnecessary frequency component from the second slave-received signal subjected to the quadrature demodulation, and outputs the signal to the mixer 69 of the first receiving unit 53.

In contrast, in the first receiving unit 53, the LNA 61 amplifies a master-received signal received by the first reception system (hereinafter, the signal may be referred to as “a first master-received signal”), and outputs the amplified first master-received signal to the quadrature demodulator 63. Furthermore, the LNA 62 amplifies a master-received signal received by the second reception system (hereinafter, the signal may be referred to as “a second master-received signal”), and outputs the amplified second master-received signal to the quadrature demodulator 64.

The quadrature demodulator 63 performs quadrature demodulation on the first master-received signal received from the LNA 61, by using a first local oscillator signal with a local frequency fl₁ output by the local oscillator 65. Subsequently, the quadrature demodulator 63 outputs the first master-received signal subjected to the quadrature demodulation to the LPF 66. The first master-received signal subjected to the quadrature demodulation contains an I signal and a Q signal. The LPF 66 removes an unnecessary frequency component from the first master-received signal subjected to the quadrature demodulation, and outputs the signal to the mixer 68.

The quadrature demodulator 64 performs quadrature demodulation on the second master-received signal received from the LNA 62, by using the first local oscillator signal with the local frequency fl₁ output by the local oscillator 65. Subsequently, the quadrature demodulator 64 outputs the second master-received signal subjected to the quadrature demodulation to the LPF 67. The second master-received signal subjected to the quadrature demodulation is an analog baseband signal containing an I signal and a Q signal. The LPF 67 removes an unnecessary frequency component from the second master-received signal subjected to the quadrature demodulation, and outputs the signal to the mixer 69.

The mixer 68 mixes the first master-received signal subjected to the quadrature demodulation by the quadrature demodulator 63 and the first slave-received signal subjected to the quadrature demodulation by the quadrature demodulator 83, to thereby obtain a first mixed signal. Furthermore, the mixer 69 mixes the second master-received signal subjected to the quadrature demodulation by the quadrature demodulator 64 and the second slave-received signal subjected to the quadrature demodulation by the quadrature demodulator 84, to thereby obtain a second mixed signal.

Incidentally, the local frequency fl₁ is set to a frequency shifted by a first offset value from a first center frequency f₁ that is common to the first master-received signal and the second master-received signal. The local frequency fl₂ is set to a frequency shifted by a second offset value from a second center frequency f₂ that is common to the first slave-received signal and the second slave-received signal. The absolute values of the first offset value and the second offset value are equal to or greater than the average of a bandwidth W₁ common to the first master-received signal and the second master-received signal and a bandwidth W₂ common to the first slave-received signal and the second slave-received signal. Furthermore, the first offset value and the second offset value have opposite signs.

By setting the local frequency fl₁ and the local frequency fl₂ as described above, the first mixed signal can contain a component corresponding to the first master-received signal and a component corresponding to the first slave-received signal such that the components do not overlap each other on the frequency axis. Furthermore, the second mixed signal can contain a component corresponding to the second master-received signal and a component corresponding to the second slave-received signal such that the components do not overlap each other on the frequency axis. Therefore, even when the master-received signal subjected to the quadrature demodulation and the slave-received signal subjected to the quadrature demodulation are mixed as a single mixed signal, it becomes possible to perform a process, such as analog-to-digital conversion, on the single mixed signal in the subsequent stage. As a result, it is possible not to provide an ADC, a DSP, a parallel-serial converter, and the like in the second receiving unit 54, so that the circuit size of the RF-LSI 50 can be reduced and power consumption can be reduced.

The ADC 70 performs a sampling process and a quantization process on the first mixed signal, and outputs the obtained digital baseband signal to the DSP 72. The DSP 72 performs a filtering process, a rate conversion process, an amplitude correction process, or the like on the digital baseband signal received from the ADC 70, in accordance with a communication system to be used, and outputs the processed digital baseband signal to the parallel-serial converter 74. Incidentally, the communication system to be used may be, for example, an LTE system, a wideband code division multiple access (WCDMA) system, or a global system for mobile communications (GSM) (registered trademark) system. The parallel-serial converter 74 converts the parallel digital baseband signal received from the DSP 72 into a serial digital baseband signal, and outputs the converted digital baseband signal to the interface 76.

The ADC 71 performs a sampling process and a quantization process on the second mixed signal, and outputs the obtained digital baseband signal to the DSP 73. The DSP 73 performs a filtering process, a rate conversion process, an amplitude correction process, or the like on the digital baseband signal received from the ADC 71, in accordance with a communication system to be used, and outputs the processed digital baseband signal to the parallel-serial converter 75. Incidentally, the communication system to be used may be, for example, an LTE system, a WCDMA system, or a GSM (registered trademark) system. The parallel-serial converter 75 converts the parallel digital baseband signal received from the DSP 73 into a serial digital baseband signal, and outputs the converted digital baseband signal to the interface 76.

The interface 76 multiplies the first digital baseband signal received from the parallel-serial converter 74, the second digital baseband signal received from the parallel-serial converter 75, and state information and various monitoring values on the RF-LSI 50 received from the CPU 91, and outputs the multiple signal to the baseband processor 12.

The CPU 91 controls the entire RF-LSI 50. For example, the CPU 91 monitors the entire RF-LSI 50 and outputs the state information and various types of monitoring information on the RF-LSI 50 to the interface 76.

The memory 92 stores therein various programs, various types of data, and the like used by the CPU 91. The CPU 91 reads the programs stored in the memory 92 and executes the programs, to thereby implement various processes.

The interface 93 receives, from the baseband processor 12, a multiple signal in which the digital baseband signal containing the I signal and the Q signal is multiplied with the control signal (RF-LSI Control). The interface 93 outputs the digital baseband signal to the serial-parallel convertor 94 and outputs the control signal to the CPU 91. The serial-parallel convertor 94 converts the serial digital baseband signal received from the interface 93 into a parallel digital baseband signal, and outputs the converted digital baseband signal to the DSP 95. The DSP 95 performs a filtering process, an interpolation process, and an amplitude adjustment process, or the like on the digital baseband signal received from the serial-parallel convertor 94, in accordance with the communication system to be used, and outputs the processed digital baseband signal to the DAC 96. The DAC 96 converts the digital baseband signal received from the DSP 95 into an analog baseband signal, and outputs the analog baseband signal to the LPF 97. The LPF 97 removes an unnecessary frequency component from the analog baseband signal received from the DAC 96, and outputs the signal to the quadrature modulator 99.

The quadrature modulator 99 performs quadrature modulation on the analog baseband signal received from the LPF 97, by using the local oscillator signal received from the local oscillator 98. Therefore, a wireless signal is obtained. The local oscillator 98 includes a VCO and a PLL. Incidentally, the frequency of the wireless signal is unambiguously determined based on the local frequency. Therefore, by controlling the local frequency, a wireless signal with a desired frequency can be obtained. The wireless signal obtained by the quadrature modulator 99 is adjusted to have desired power by the VGA 100 and thereafter output from the RF-LSI 50.

The power supply controller 101 controls supply of electric power to each of the functional units of the RF-LSI 50. The clock supply controller 102 controls supply of a clock signal to each of the functional units of the RF-LSI 50.

Processing Operation by the RF-LSI

Processing operation performed by the RF-LSI 50 configured as above will be explained below. In particular, the frequency conversion process will be explained below.

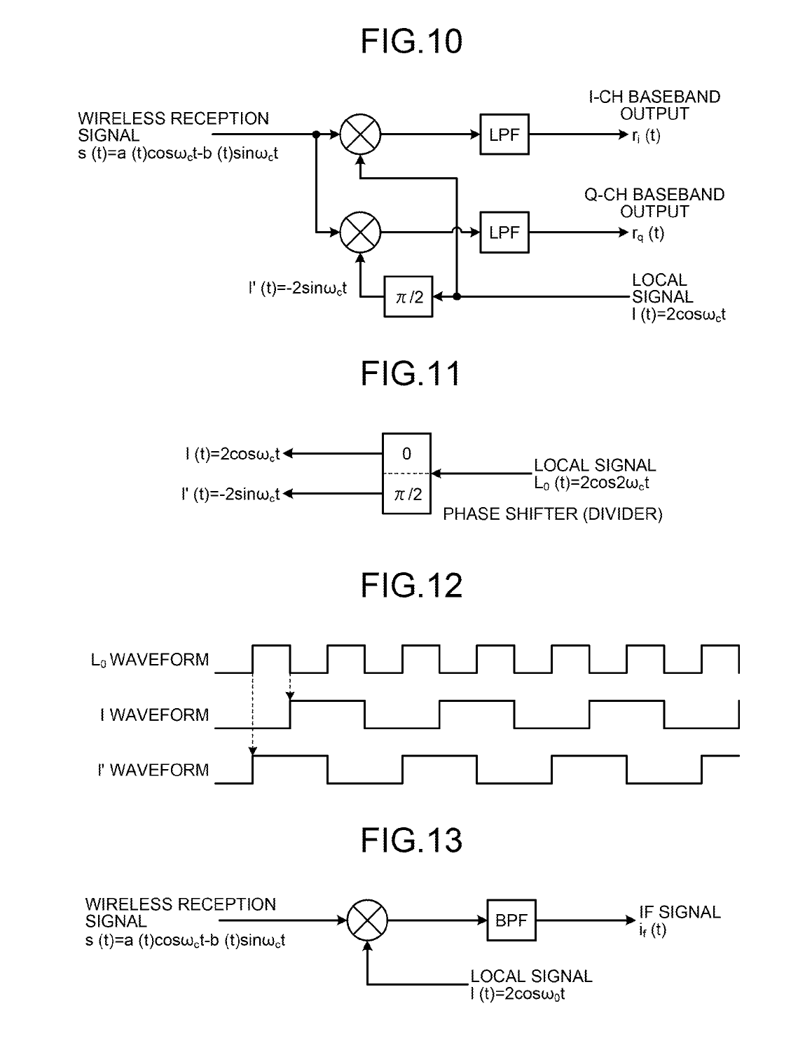

First, the operating principle of the quadrature demodulator will be explained below. FIG. 10 is a diagram illustrating a general configuration of the quadrature demodulator.

As illustrated in FIG. 10, local signals that are out of phase with each other by π/2 are respectively input to two mixers. Each of the mixers multiplies the input local signal by the wireless reception signal to obtain a baseband signal, and outputs the baseband signal via the LPF. Incidentally, the frequency of the local signal and the frequency of the wireless reception signal are the same. Accordingly, one of the mixers obtains an I-channel baseband signal, and the other one of the mixers obtains a Q-channel baseband signal. Meanwhile, as illustrated in FIG. 11, a phase shifter may be used to generate two local signals that are out of phase with each other by π/2. FIG. 11 is a diagram for explaining the phase shifter. FIG. 12 is a diagram for explaining a relationship between an input signal and an output signal of the phase shifter. As illustrated in FIG. 12, if a single local signal is input to the phase shifter illustrated in FIG. 11, the phase shifter outputs two local signals that are out of phase with each other by π/2. In this case, the frequencies of the output local signals are twice as much as the frequency of the input local signal.

FIG. 13 illustrates a configuration of a general frequency converter. As can be seen from FIG. 10 and FIG. 13, the operating principle is basically the same between the quadrature demodulator and the frequency converter.

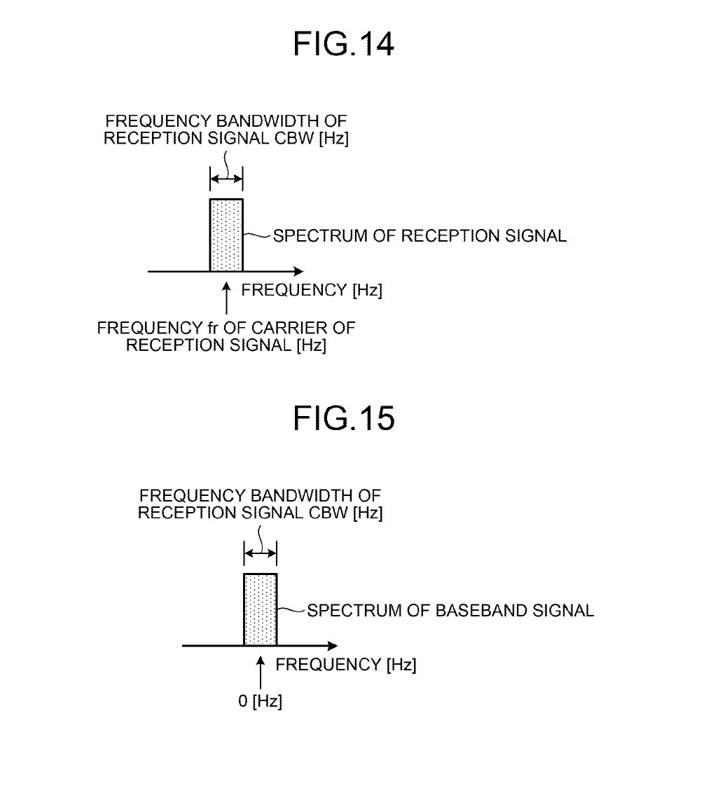

For example, the quadrature demodulator performs frequency conversion on a modulation signal of a carrier at fr (see FIG. 14) to obtain a modulation signal of a carrier at 0 Hz, that is, a baseband signal (see FIG. 15). For example, because the frequency of the wireless reception signal and the frequency of the local signal are the same, a baseband signal with the frequency of 0 Hz corresponding to a difference between the frequencies of these signal is obtained. FIGS. 14 and 15 are diagrams for explaining the frequency conversion through the quadrature demodulation.

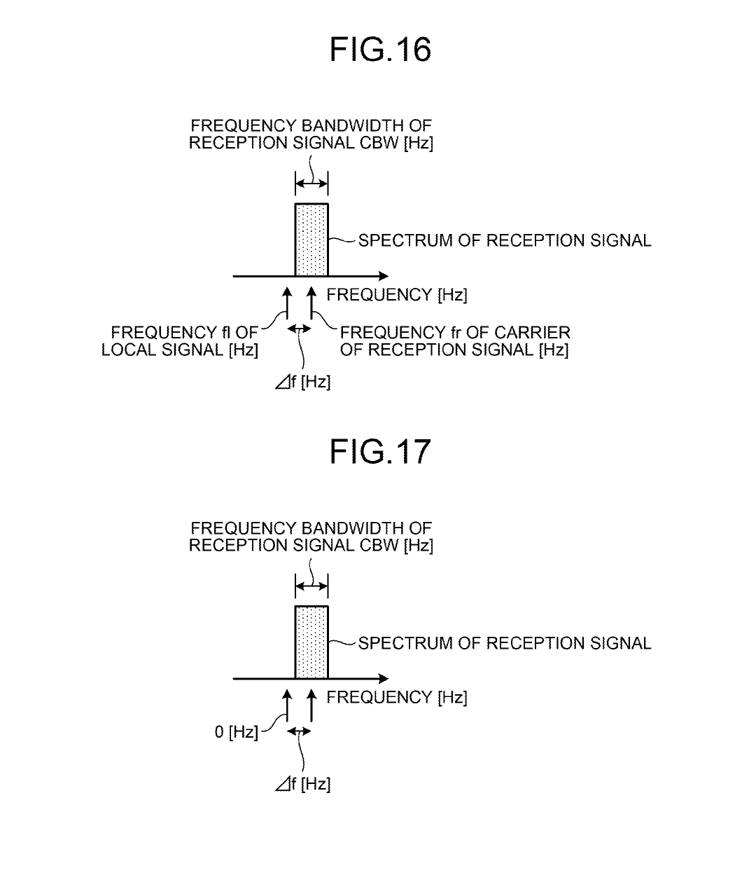

As described above, the frequency of a baseband signal (see FIG. 17) obtained by using a local signal with a frequency fl (see FIG. 16), which is shifted by a predetermined offset value Δf from the frequency fr of the received wireless signal, is shifted by Δf from 0 Hz. FIGS. 16 and 17 are diagrams for explaining the frequency conversion through the quadrature demodulation.

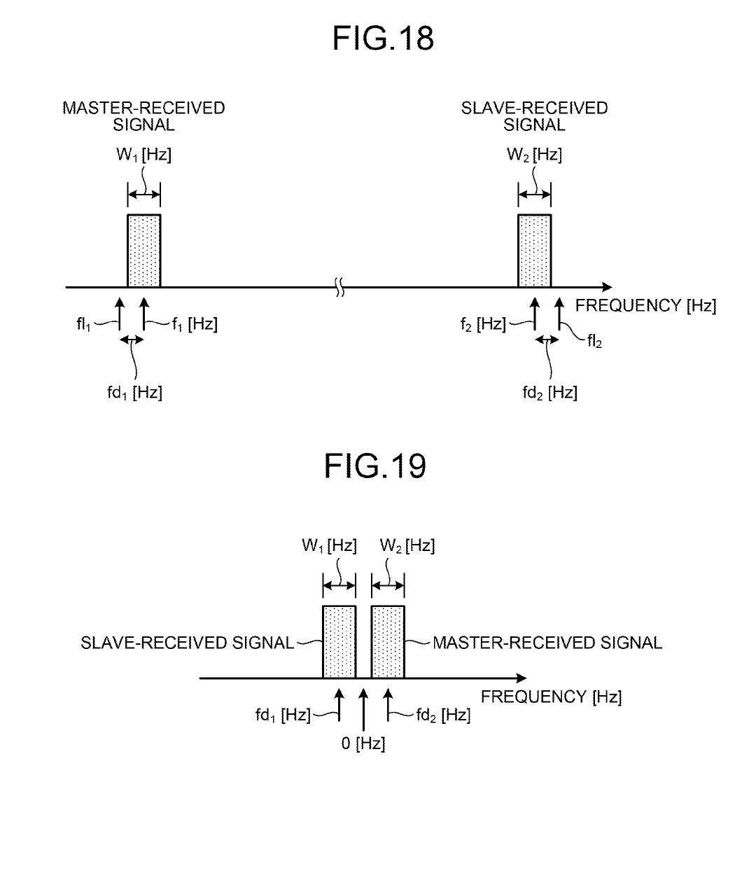

The frequency converter 55 as described above uses the above principle. For example, as described above, the local frequency fl₁ is set to the frequency shifted by a first offset value fd₁ from the first center frequency f₁ that is common to the first master-received signal and the second master-received signal. Furthermore, the local frequency fl₂ is set to a frequency shifted by a second offset value fd₂ from the second center frequency f₂ that is common to the first slave-received signal and the second slave-received signal (see FIG. 18). Moreover, the absolute values of the first offset value and the second offset value are equal to or greater than the average of the bandwidth W₁ common to the first master-received signal and the second master-received signal and the bandwidth W₂ common to the first slave-received signal and the second slave-received signal. Furthermore, the first offset value and the second offset value have opposite signs. FIG. 18 is a diagram for explaining the frequency conversion process performed by the frequency converter according to the first embodiment.

By setting the local frequency fl₁ and the local frequency fl₂ as described above, a baseband signal corresponding to the master-received signal and a baseband signal corresponding to the slave-received signal are obtained such that the baseband signals do not overlap each other on the frequency axis (see FIG. 19). In other words, it becomes possible to obtain a master-side baseband signal and a slave-side baseband signal, which do not overlap each other on the frequency axis and the frequency of each of which falls within a range containing the reference frequency and having a predetermined bandwidth. In this case, the reference frequency is 0 Hz. FIG. 19 is a diagram for explaining the frequency conversion process performed by the frequency converter according to the first embodiment.

For example, the mixer 68 can obtain the first mixed signal containing a component corresponding to the first master-received signal and a component corresponding to the first slave-received signal such that the components do not overlap each other on the frequency axis. Furthermore, the mixer 69 can obtain the second mixed signal containing a component corresponding to the second master-received signal and a component corresponding to the second slave-received signal such that the components do not overlap each other on the frequency axis. Therefore, even when the master-received signal subjected to the quadrature demodulation and the slave-received signal subjected to the quadrature demodulation are mixed as a single mixed signal, it becomes possible to perform a process, such as analog-to-digital conversion, on the single mixed signal in the subsequent stage. As a result, it is possible not to provide an ADC, a DSP, a parallel-serial converter, and the like in the second receiving unit 54, so that the circuit size of the RF-LSI 50 can be reduced and power consumption can be reduced.

As described above, according to the first embodiment, the RF-LSI 50 receives a first signal transmitted with a first frequency and a second signal transmitted with a second frequency. In the RF-LSI 50, the frequency converter 55 performs frequency conversion on the received first signal (i.e., the master-received signal) and the received second signal (i.e., the slave-received signal) such that the first and the second signals do not overlap each other on the frequency axis and such that the frequency of each of the first and the second signals falls within a range contain the reference frequency and having a predetermined bandwidth. Subsequently, the mixer 56 mixes the frequency-converted first signal and the frequency-converted second signal. Then, the ADC 57 performs analog-to-digital conversion on the mixed signal.

In the configuration of the RF-LSI 50 as described above, even when the master-received signal subjected to the quadrature demodulation and the slave-received signal subjected to the quadrature demodulation are mixed as a single mixed signal, it becomes possible to perform a process, such as analog-to-digital conversion, on the single mixed signal in the subsequent stage. As a result, it becomes possible to integrate the processing units, such as the ADC, into a single unit, so that the circuit size of the RF-LSI 50 can be reduced and power consumption can be reduced.

For example, the frequency converter 55 includes the quadrature demodulator 63 and the quadrature demodulator 83. The quadrature demodulator 63 performs quadrature demodulation on the master-received signal by using a first local oscillator signal with a frequency shifted by the first offset value fd₁ from the center frequency f₁ of the master-received signal. Furthermore, the quadrature demodulator 83 performs quadrature demodulation on the slave-received signal by using a second local oscillator signal with a frequency shifted by the second offset value fd₂ from the center frequency f2 of the slave-received signal. Moreover, the absolute values of the first offset value and the second offset value are equal to or greater than the average of the bandwidth W₁ of the master-received signal and the bandwidth W₂ of the slave-received signal, and the first offset value and the second offset value have opposite signs.

Incidentally, the frequency of the first local oscillator signal and the frequency of the second local oscillator signal may be set commonly for all of the frequencies in the operating band in which the reception signals are transmitted, or may be set for each of actual frequencies at which the reception signals are transmitted in the operating band. In the former case, “the range containing the reference frequency and having a predetermined bandwidth” as described above has a bandwidth at least equal to or greater than the operating band.

### [b] Second Embodiment

In a second embodiment, a local oscillator is shared by the first receiving unit and the second receiving unit. The basic configuration of the multi-antenna communication apparatus and the basic configuration of the wireless transmitting/receiving circuit are the same between the second embodiment and the first embodiment (see FIGS. 6, 7, and 8). However, the circuit configuration of the RF-LSI differs between the second embodiment and the first embodiment.

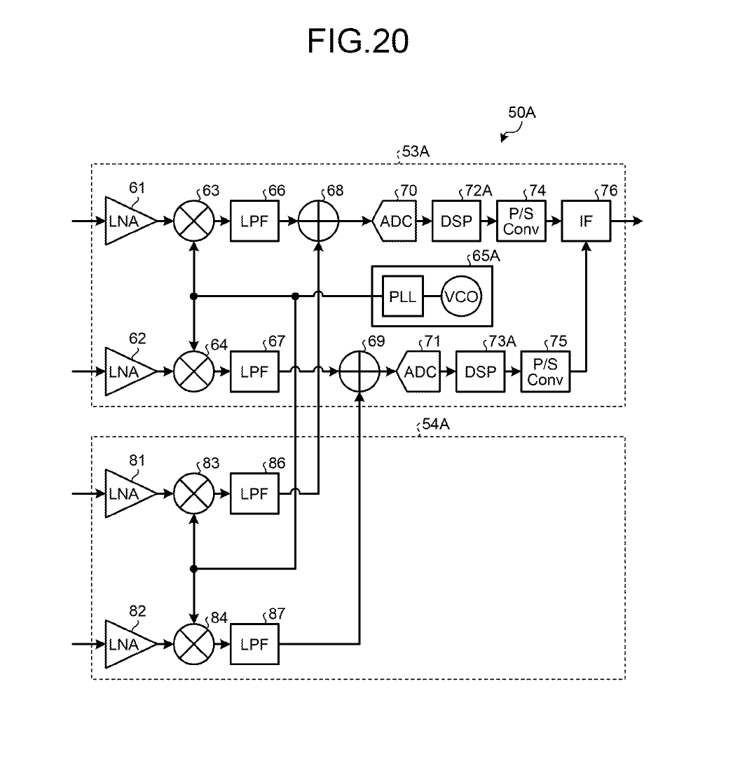

FIG. 20 is a block diagram illustrating an example of a specific circuit configuration of an RF-LSI according to the second embodiment. As illustrated in FIG. 20, an RF-LSI 50A includes a first receiving unit 53A and a second receiving unit 54A. The first receiving unit 53A includes a local oscillator 65A and DSPs 72A and 73A.

The local oscillator 65A outputs a third local oscillator signal with a local frequency fl₃ to the quadrature demodulators 63, 64, 83, and 84. Each of the quadrature demodulators 63, 64, 83, and 84 performs quadrature demodulation on a reception signal by using the third local oscillator signal.

The local frequency fl₃ is a frequency between the first center frequency f₁ common to the first master-received signal and the second master-received signal and the second center frequency f₂ common to the first slave-received signal and the second slave-received signal. For example, the local frequency fl₃ is shifted from a median value of the first center frequency f₁ and the second center frequency f₂ by a value that is obtained by multiplying the sum of the bandwidth W₁ of the master-received signal and the bandwidth W₂ of the slave-received signal by ¼. In this case, the reference frequency is the median value of the first center frequency f₁ and the second center frequency f₂.

By setting the local frequency fl₃ as described above, the first mixed signal can contain a component corresponding to the first master-received signal and a component corresponding to the first slave-received signal such that the components do not overlap each other on the frequency axis. Furthermore, the second mixed signal can contain a component corresponding to the second master-received signal and a component corresponding to the second slave-received signal such that the components do not overlap each other on the frequency axis. Therefore, even when the master-received signal subjected to the quadrature demodulation and the slave-received signal subjected to the quadrature demodulation are mixed as a single mixed signal, it becomes possible to perform a process, such as analog-to-digital conversion, on the single mixed signal in the subsequent stage. As a result, it is possible not to provide an ADC, a DSP, a parallel-serial converter, and the like in the second receiving unit 54A, so that the circuit size of the RF-LSI 50A can be reduced and power consumption can be reduced.

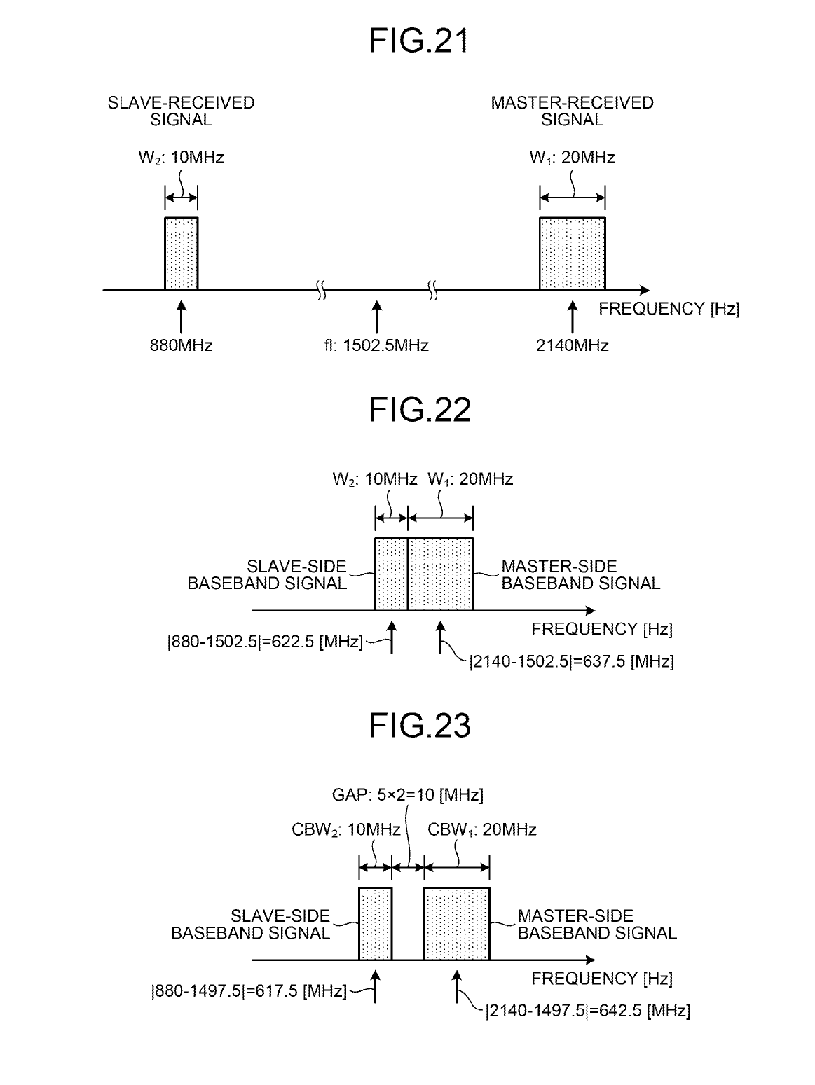

The frequency conversion process according to the second embodiment will be explained in detail below. FIGS. 21 and 22 are diagrams for explaining a frequency conversion process performed by the frequency converter according to the second embodiment.

First, if the local frequency fl₃ is set to the median value of the first center frequency f₁ and the second center frequency f₂, that is, (f₁+f₂)/2, the frequencies of all of output signals of the quadrature demodulators 63, 64, 83, and 84 become the same. Therefore, if the output signals are mixed, the frequencies overlap one another and the mixed signals are not separated.

Therefore, for example, the local frequency fl₃ is set to a frequency separated from the median value of the first center frequency f₁ and the second center frequency f₂ by a value that is obtained by multiplying the sum of the bandwidth W₁ of the master-received signal and the bandwidth W₂ of the slave-received signal by ¼. Furthermore, it is assumed that f₁=2140 MHz, W₁=20 MHz, f₂=880 MHz, and W₂=10 MHz (see FIG. 21).

In this case, the local frequency fl₃ is calculated as follows.

fl₃=(f₁+f₂)/2−(W₁+W₂)/4=(2140+80)−(20+10)/4=1502.5 [MHz]

Therefore, the frequency of the frequency-converted master-received signal becomes 637.5 [MHz] (=|2410−1502.5|).

Furthermore, the frequency of the frequency-converted slave-received signal becomes 622.5 [MHz] (=|880−1502.5|).

As a result, as illustrated in FIG. 22, it becomes possible to mix (synthesize) the frequency-converted master-received signal and the frequency-converted slave-received signal such that the frequencies do not overlap each other.

Meanwhile, in FIG. 22, the frequency of the frequency-converted master-received signal and the frequency of the frequency-converted slave-received signal are continuous. In this case, it may become difficult to separate components corresponding to the respective signals in a process subsequent to the frequency conversion process. In this case, it is preferable to set the local frequency fl₃ to a frequency greatly shifted from the median value of the first center frequency f₁ and the second center frequency f₂ by a value obtained by multiplying the sum of the bandwidth W₁ of the master-received signal and the bandwidth W₂ of the slave-received signal by ¼.

Therefore, for example, it is assumed that the amount of shift from the median value is set to (W₁+W₂)/4+5 [MHz]. In this case, the local frequency fl₃ is calculated as follows.

fl₃=(f₁+f₂)/2−((W₁+W₂)/4+5)=(2140+880)−((20+10)/4+5)=1497.5 [MHz]

Therefore, the frequency of the frequency-converted master-received signal becomes 642.5 [MHz] (=|2410−1497.5|).

Furthermore, the frequency of the frequency-converted slave-received signal becomes 617.5 [MHz] (=|880−1497.5|).

As a result, as illustrated in FIG. 23, it becomes possible to set a gap of 10 MHz (=5 [MHz]×2) between the frequency of the frequency-converted master-received signal and the frequency of the frequency-converted slave-received signal. Consequently, it becomes possible to easily separate the components of the respective signals in a subsequent process. FIG. 23 is a diagram for explaining the frequency conversion process performed by the frequency converter according to the second embodiment.

Referring back to FIG. 20, the DSPs 72A and 73A perform a process for converting an input signal to a baseband signal with the center frequency of 0 Hz, in addition to the processes performed by the DSPs 72 and 73. The reason for this is that the frequencies of the master-received signal and the slave-received signal subjected to the frequency conversion by the quadrature demodulators 63, 64, 83, and 84 are relatively high and may be not suitable for serial transmission with respect to the baseband processor 12. Meanwhile, the additional process is implemented by a simple integrator, so that an increase in the power consumption and an increase in the circuit size due to the additional process are small.

As described above, according to the second embodiment, the frequency converter 55 of the RF-LSI 50A includes the quadrature demodulator 63 and the quadrature demodulator 83. The quadrature demodulator 63 performs quadrature demodulation on the master-received signal by using the third local oscillator signal with the frequency between the center frequency f₁ of the master-received signal and the center frequency f₂ of the slave-received signal. Furthermore, the quadrature demodulator 83 performs quadrature demodulation on the slave-received signal by using the third local oscillator signal.

With the configuration of the RF-LSI 50A as described above, it becomes possible to integrate the local oscillator into one unit, so that the circuit size and the power consumption can further be reduced.

For example, the frequency of the third local oscillator signal is shifted from the median value of the center frequency f₁ of the master-received signal and the center frequency f₂ of the slave-received signal by a value obtained by multiplying the sum of the bandwidth W₁ of the master-received signal and the bandwidth W₂ of the slave-received signal by ¼.

The second embodiment may be modified as described below.

First Modification

In the circuit configuration illustrated in FIG. 20, the ADCs 70 and 71 need to have the capability to sample signals at frequencies of hundreds of megahertz or greater. To cope with the case where it is difficult to mount the above-described ADC, a frequency converter (mixer) is provided in an input stage of the ADC.

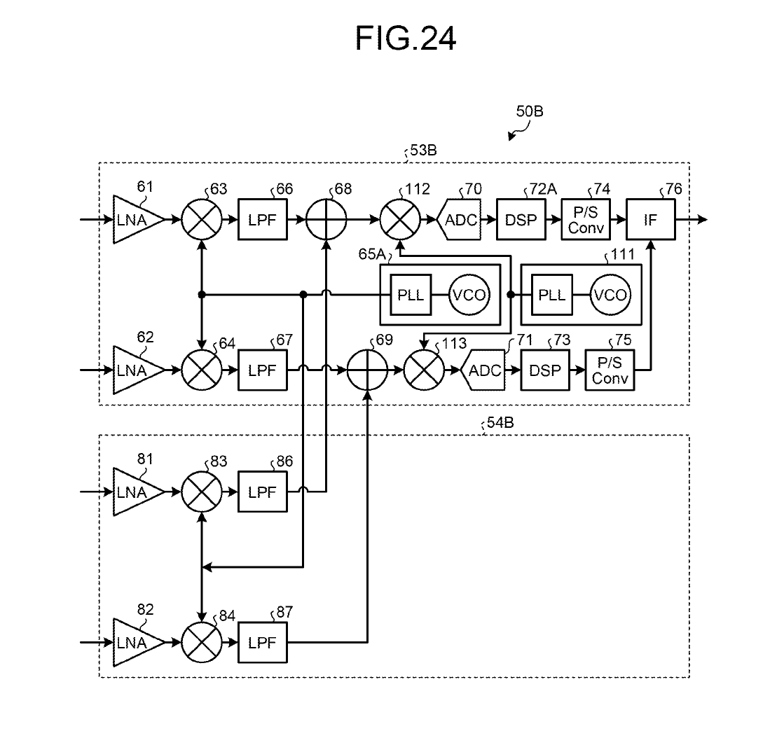

FIG. 24 is a block diagram illustrating a configuration of an RF-LSI according to a first modification of the second embodiment. In FIG. 24, an RF-LSI 50B includes a first receiving unit 53B and a second receiving unit 54B. The second receiving unit 54B has the same configuration as the second receiving unit 54A. The first receiving unit 53B includes a local oscillator 111 and mixers 112 and 113. The mixers 112 and 113 convert the first mixed signal and the second mixed signal into baseband signals each having the center frequency of 0 Hz. Therefore, it becomes possible to reduce the operating frequencies of the ADCs 70 and 71.

Second Modification

The configuration of the first modification is equivalent to the configuration of a superheterodyne. Therefore, even if the arrangement positions of the quadrature demodulators 63 and 64 and the arrangement positions of the mixers 112 and 113 are interchanged, problems can hardly occur.

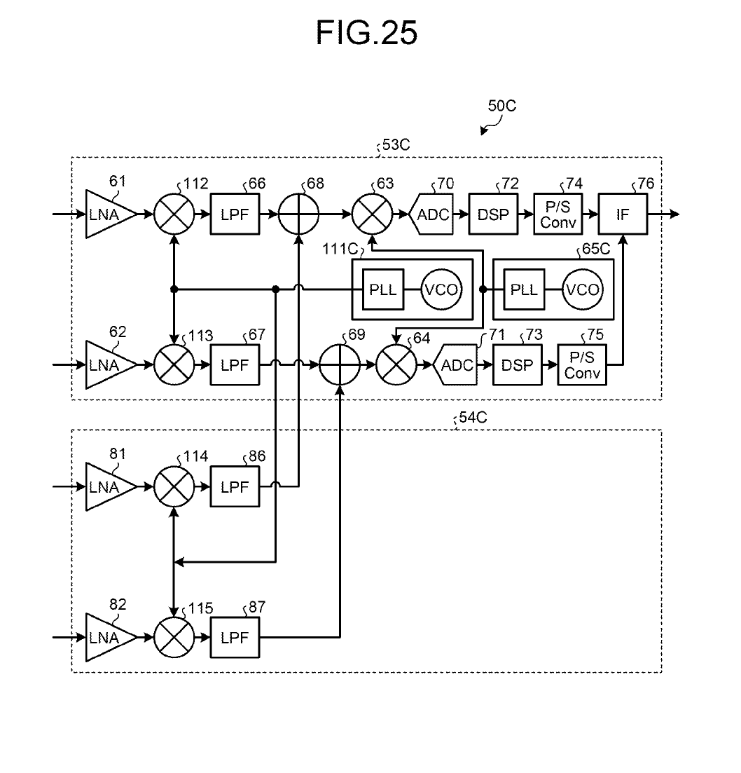

FIG. 25 is a block diagram illustrating a configuration of an RF-LSI according to a second modification of the second embodiment. In FIG. 25, an RF-LSI 50C includes a first receiving unit 53C and a second receiving unit 54C. In the first receiving unit 53C, the arrangement positions of the quadrature demodulators 63 and 64 and the arrangement positions of the mixers 112 and 113 are interchanged, compared with the first receiving unit 53B. Furthermore, the second receiving unit 54C includes mixers 114 and 115 instead of the quadrature demodulators 83 and 84. Each of the mixers 112, 113, 114, and 115 simply performs frequency conversion; therefore, an intermediate frequency (IF) signal is output instead of an I signal and a Q signal. A local oscillator 111C outputs a local oscillator signal used to obtain the intermediate frequency signal by the mixers 112, 113, 114, and 115.

The quadrature demodulators 63 and 64 perform quadrature demodulation on the first mixed signal and the second mixed signal by using the local oscillator signal output by a local oscillator 65C. Incidentally, the frequency of the local oscillator signal output by the local oscillator 65C may be set to a frequency shifted from a median value of a frequency f₁′ of a signal component corresponding to the master-received signal and a frequency f₂′ of the signal component corresponding to the slave-received signal contained in the mixed signal, by a value obtained by multiplying the sum of the bandwidth W₁ of the master-received signal and the bandwidth W₂ of the slave-received signal by ¼.

In the configurations of the first and the second modifications, the number of the local oscillators is the same as that of the configuration of the first embodiment. However, in the configurations of the first and the second modifications, the frequency of the local oscillator signal output by one of the local oscillators is reduced. Therefore, it becomes possible to reduce the power consumption compared with the first embodiment.

Furthermore, the frequency of the third local oscillator signal may be set commonly for all of the frequencies in the operating band in which reception signals are transmitted, or may be set for each of actual frequencies at which the reception signals are actually transmitted. In the former case, “the range containing the reference frequency and having a predetermined bandwidth” as described above has a bandwidth at least equal to or greater than the operating band.

### [c] Third Embodiment

In a third embodiment, a master-received signal with a radio frequency and a slave-received signal with a radio frequency are mixed, and a quadrature demodulation process is performed on the mixed signal. The basic configuration of the multi-antenna communication apparatus and the basic configuration of the wireless transmitting/receiving circuit are the same between the third embodiment and the first embodiment (see FIGS. 6 and 7). However, in the third embodiment, the quadrature demodulator (the frequency converter) and the mixer are arranged in the reverse order of the first embodiment.

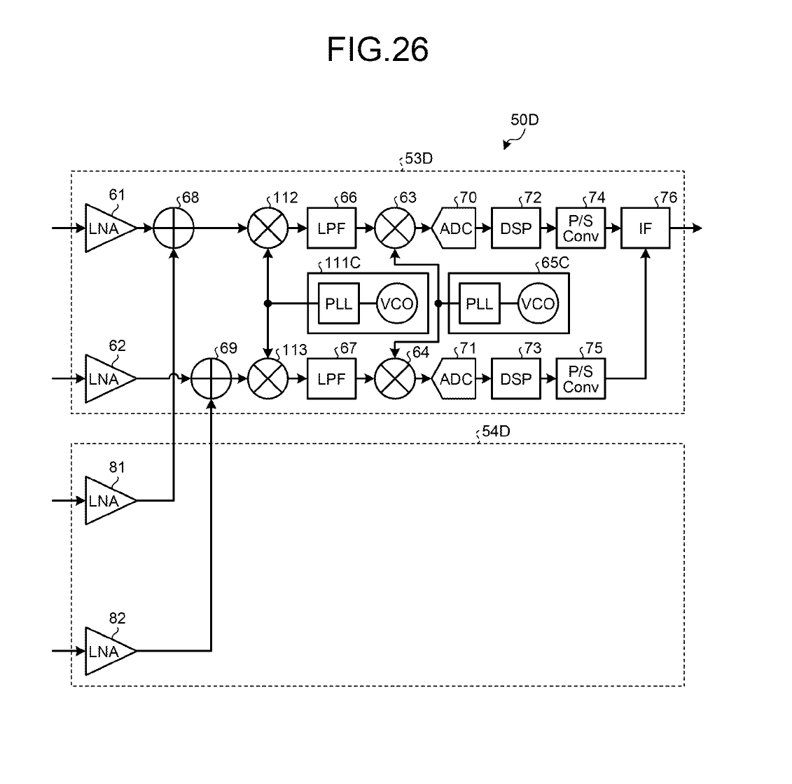

FIG. 26 is a block diagram illustrating an example of a specific circuit configuration of an RF-LSI according to the third embodiment. As illustrated in FIG. 26, an RF-LSI 50D includes a first receiving unit 53D and a second receiving unit 54D.

Components of the first receiving unit 53D are the same as those of the first receiving unit 53C. However, the mixers 68 and 69 are arranged in the input stage of the mixers 112 and 113. For example, if the RF-LSI 50D is illustrated in functional blocks similarly to FIG. 8, the frequency converters are provided in the output stage of the mixers. The mixers 68 and 69 mix a master-received signal with a radio frequency and a slave-received signal with a radio frequency, and outputs the mixed signal to the processing units in the subsequent stage.

As described above, according to the third embodiment, the RF-LSI 50D receives a first signal transmitted with a first frequency and a second signal transmitted with a second frequency. In the RF-LSI 50D, the mixer (the mixer 68 or the mixer 69) mixes the received first signal (i.e., the master-received signal) and the received second signal (i.e., the slave-received signal). Subsequently, the frequency converter (the quadrature demodulator 63 or the quadrature demodulator 64) performs frequency conversion on the mixed signal, and outputs the frequency-converted mixed signal containing a frequency-converted first signal component and a frequency-converted second signal component such that the components do not overlap each other on the frequency axis and the frequency of each of which falls within a range containing the reference frequency and having a predetermined bandwidth. Then, the ADC (the ADC 70 or the ADC 71) performs analog-to-digital conversion on the frequency-converted mixed signal.

With the configuration of the RF-LSI 50D as described above, it becomes possible to integrate the quadrature demodulators into one unit, so that the circuit size and the power consumption can further be reduced.

According to an embodiment of the present invention, it is possible to simplify the circuit configuration and realize low power consumption.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A receiving apparatus configured to receive a first signal transmitted with a first frequency and a second signal transmitted with a second frequency, the receiving circuit comprising:
a frequency converter configured to perform frequency conversion on the received first signal and the received second signal, and output a frequency-converted first signal and a frequency-converted second signal, the frequency-converted first and second signals not overlapping each other on a frequency axis and the frequency of each of the frequency-converted first and second signals falling within a range containing a reference frequency and having a predetermined bandwidth;
a mixer configured to mix the frequency-converted first signal and the frequency-converted second signal to obtain a mixed signal; and
an analog-to-digital converter configured to perform analog-to-digital conversion on the mixed signal.

2. The receiving apparatus according to claim 1, wherein
the frequency converter includes
a first quadrature demodulator configured to perform quadrature demodulation on the received first signal by using a first local signal with a first local frequency shifted by a first offset value from a center frequency of the received first signal; and
a second quadrature demodulator configured to perform quadrature demodulation on the received second signal by using a second local signal with a second local frequency shifted by a second offset value by a center frequency of the received second signal.

3. The receiving apparatus according to claim 2, wherein
absolute values of the first offset value and the second offset value are equal to or greater than an average of a bandwidth of the received first signal and a bandwidth of the received second signal, and
the first offset value and the second offset value have opposite signs.

4. The receiving apparatus according to claim 1, wherein
the frequency converter includes
a first quadrature demodulator configured to perform quadrature demodulation on the received first signal by using a third local signal with a third local frequency between a center frequency of the received first signal and a center frequency of the received second signal; and
a second quadrature demodulator configured to perform quadrature demodulation on the received second signal by using the third local signal.

5. The receiving apparatus according to claim 4, wherein
the third local frequency is shifted from a median value of the center frequency of the received first signal and the center frequency of the received second signal by at least a value obtained by multiplying a sum of the bandwidth of the received first signal and the bandwidth of the received second signal by ¼.

6. A receiving apparatus configured to receive a first signal transmitted with a first frequency and a second signal transmitted with a second frequency, the receiving circuit comprising:
a mixer configured to mix the received first signal and the received second signal, and outputs a mixed signal containing a first signal component corresponding to the first signal and a second signal component corresponding to the second signal;
a frequency converter configured to perform frequency conversion on the mixed signal, and output a frequency-converted mixed signal containing a frequency-converted first signal component and a frequency-converted second signal component, the frequency-converted first and second signal components not overlapping each other on the frequency axis and a frequency of each of the frequency-converted first and second signal components falling within a range containing a reference frequency and having a predetermined bandwidth; and
an analog-to-digital converter configured to perform analog-to-digital conversion on the frequency-converted mixed signal.

7. A receiving method for receiving a first signal transmitted with a first frequency and a second signal transmitted with a second frequency, the receiving method comprising:
performing frequency conversion on the received first signal and the received second signal to generate a frequency-converted first signal and a frequency-converted second signal, the frequency-converted first and second signals not overlapping each other and a frequency of each of the frequency-converted first and second signals falling within a range containing a reference frequency and having a predetermined bandwidth;
mixing the frequency-converted first signal and the frequency-converted second signal to obtain a mixed signal; and
performing analog-to-digital conversion on the mixed signal.
